(19) United States
(12) Patent Application Publication
(10) Pub. No.: US 2016/0048892 A1
(43) Pub. Date: Feb. 18, 2016

(54) LOCATION AND TIME-BASED CONVERSATIONS FOR DISCUSSING RELEVANT INFORMATION

(71) Applicants: Bryant Genepang Luk, Round Rock, TX (US); Robert He, Pflugerville, TX (US); Christopher Diebold O'Toole, Cedar Park, TX (US)

(72) Inventors: Bryant Genepang Luk, Round Rock, TX (US); Robert He, Pflugerville, TX (US); Christopher Diebold O'Toole, Cedar Park, TX (US)

(21) Appl. No.: 14/460,307

(22) Filed: Aug. 14, 2014

(51) Int. Cl. G06Q 30/06; G06Q 30/02

(52) U.S. Cl. CPC G06Q 30/0601; G06Q 30/0282

(57) ABSTRACT

A system, method, and computer readable medium is provided to identify a user that can provide relevant information to another user currently located at a particular location. A device location (DL) manager receives first data indicating a presence of a first computing device at a location that corresponds to an item. The first computing device is associated with a first user account. The DL manager sends a first notification to the first user account due to activity related to the item by a second user account. The first notification identifies the second user account. The DL manager receives a message from the first user account for the second user account.

### TECHNICAL FIELD

This application relates to data processing. In particular, example embodiments may relate to systems and methods of receiving and processing location-based data.

### BACKGROUND

Typical electronic commerce (“e-commerce) sites provide users (e.g., sellers) with computer-implemented services for selling goods or services through, for example, a website. For example, a seller may submit information regarding a good or service to the e-commerce site through a web-based interface. Upon receiving the information regarding the good or service, the e-commerce site may store the information as a listing that offers the good or service for sale. Other users (e.g., buyers) interface with the e-commerce site through a search interface to find goods or services to purchase. For example, some typical e-commerce sites may allow the user to submit a search query that includes, for example, search terms that may be matched by the e-commerce site against the listings created by the sellers. Listings that match the submitted search query may be presented to the buyer as a search result and the buy may then select one of the listing to effectuate a purchase.

### BRIEF DESCRIPTION OF THE DRAWINGS

The present invention is illustrated by way of example, and not by way of limitation, in the figures of the accompanying drawings in which:

FIG. 1 is a network diagram depicting a publication system, according to one embodiment, having a client-server architecture configured for exchanging data over a network;

FIG. 2 is a block diagram illustrating components of a device location manager, according to some example embodiments;

FIG. 3 is a flowchart illustrating operations of a method of identifying one or more user accounts with activities related to an item, according to some example embodiments;

FIG. 4 is a flowchart illustrating operations of a method of creating a forum for user accounts, according to some example embodiments;

FIG. 5 shows a diagrammatic representation of machine in the example form of a computer system within which a set of instructions may be executed causing the machine to perform any one or more of the methodologies discussed herein.

### DETAILED DESCRIPTION

A system, method, and computer readable medium is provided to identify a user that can provide relevant information to another user currently located at a particular location. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Although example embodiments have been described with reference to specific examples, it is to be appreciated that various modifications and changes may be made to these embodiments without departing from the broader spirit and scope of the invention. Accordingly, the specification and drawings are to be regarded in an illustrative rather than a restrictive sense.

In various embodiments, a device location (DL) manager receives first data indicating a presence of a first computing device at a location that corresponds to an item. The first computing device is associated with a first user account. The DL manager sends a first notification to the first user account due to activity related to the item by a second user account. The first notification identifies the second user account. The DL manager receives a message from the first user account for the second user account.

In some embodiments, a user carrying a wireless mobile device may be located in a store or any other kind of physical retail space. The user may be near a particular item in the store and may wish to receive information from a person with recent and personal experience with the item. The DL manager takes into account the wireless mobile device's current location and the current time in order to identify other user who may be able to provide information about the item.

For example, the DL manager receives data from the wireless mobile device associated with a first user account. The data indicates presence of the wireless mobile device in a store. The data may further indicate the wireless mobile device is proximate to an item in the store. The DL manager accesses a database(s) containing records, logged events, detected locations and/or data describing activities of other user accounts.

The DL manager identifies activities of a second user account related to the item. For example, the DL manager identifies a purchase of the item by the second user account. In another example, the DL manager identifies a review of the item received from the second user account. In yet another example, the DL manager detects that a mobile wireless device associated with the second user account is also proximate to the item—or currently located within a range from the current location of the mobile wireless device associated with the first user account. In another example, the DL manager detects that the mobile wireless device associated with the second user account was recently proximate to the item—or recently located within a range from the current location of the mobile wireless device associated with the first user account (“current location”). The DL manager can further identify one or more mobile wireless devices associated with respective user accounts that were within a range from the current location within a period of time as measured from the current time.

Based on the activities of the second user account with respect to the item, the DL manager determines that the user of the second user account will be able to provide the user of the first user account with highly relevant information about the item. The DL manager sends a notification to the first user account identifying the second user account.

If the user associated with the first user account wishes to contact the second user account in order to inquire about the item, the first user account sends a message to the second user account. The DL manager receives the message and forwards the message to the second user account.

### Platform Architecture

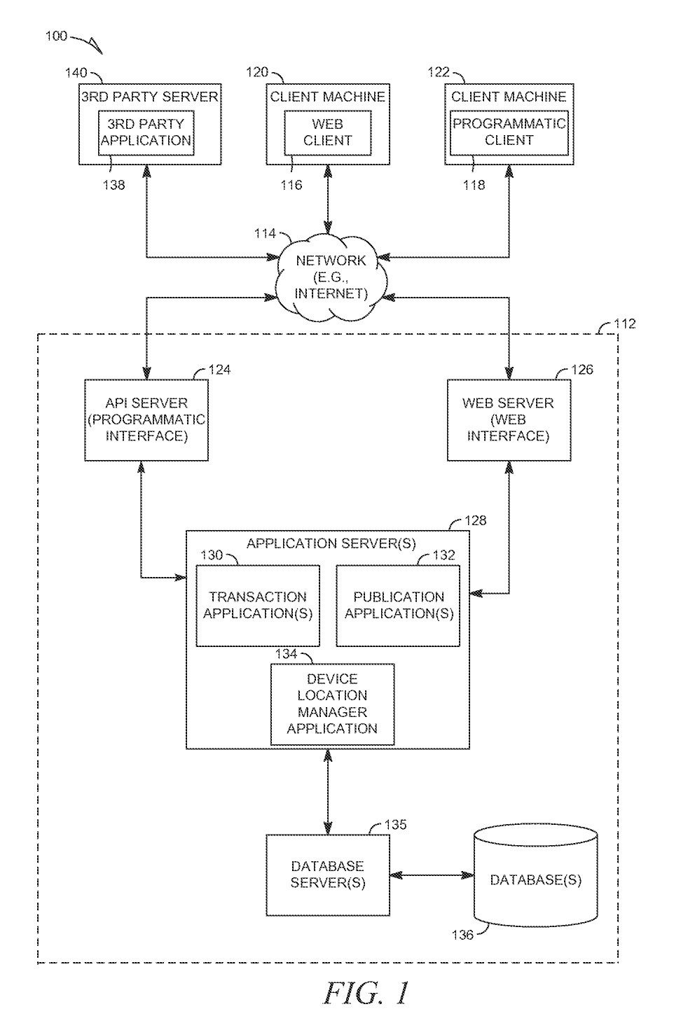

FIG. 1 is a network diagram depicting a publication system 100, according to one embodiment, having a client-server architecture configured for exchanging data over a network. The publication system 100 may be a transaction system where clients, through client machines 120, 122 and a third party server 140, may communicate, view, search, and exchange data with network based publisher 112. For example, the publication system 100 may include various applications for interfacing with client machines and client applications that may be used by users (e.g., buyers and sellers) of the system to publish items for sale in addition to facilitating the purchase and shipment of items.

The network based publisher 112 may provide server-side functionality, via a network 114 (e.g., the Internet) to one or more clients. The one or more clients may include users that utilize the network based publisher 112 as a transaction intermediary to facilitate the exchange of data over the network 114 corresponding to user transactions. User transactions may include receiving and processing item and item related data and user data from a multitude of users, such as payment data, shipping data, item review data, feedback data, etc. A transaction intermediary such as the network based publisher 112 may include one or all of the functions associated with a shipping service broker, payment service and other functions associated with transactions between one or more parties. For simplicity, these functions are discussed as being an integral part of the network based publisher 112, however it is to be appreciated that these functions may be provided by publication systems remotely and/or decoupled from the network based publisher 112.

In various embodiments, the data exchanges within the publication system 100 may be dependent upon user selected functions available through one or more client/user interfaces (UIs). The UIs may be associated with a client machine, such as the client machine 120, utilizing a web client 116. The web client 116 may be in communication with the network based publisher 112 via a web server 126. The UIs may also be associated with a client machine 122 utilizing a client application 118, or a third party server 140 hosting a third party application 1138. It can be appreciated in various embodiments the client machine 120, 122 may be associated with a buyer, a seller, payment service provider or shipping service provider, each in communication with the network based publisher 112 and optionally each other. The buyers and sellers may be any one of individuals, merchants, etc.

An application program interface (API) server 124 and a web server 126 provide programmatic and web interfaces to one or more application servers 128. The application servers 128 may host one or more other applications, such as transaction applications 130 and publication applications 132. The application servers 128 may be coupled to one or more data servers 135 that facilitate access to one or more storage devices, such as the data storage 136.

The transaction applications 130 may provide a number of payment processing modules to facilitate processing payment information associated with a buyer purchasing an item from a seller. The publication applications 132 may include various modules to provide a number of publication functions and services to users that access the network based publisher 112. For example, these services may include, inter alia, formatting and delivering search results to a client. The device location manager application 134, may include various modules to identify a user associated with a user account that can provide relevant information about one or more items.

For example, these services may include, inter alia, identifying a current location of a wireless mobile device associated a first user account, where the current location is proximate to an item. The services of the device location manager application 134 further includes identifying activities of a second user account that involve the item and providing a notification to the first user account, where the notification identifies the second user account. It is understood that the device location manager application 134 may identify multiple user accounts.

FIG. 1 also illustrates an example embodiment of a third party application 138, which may operate on a third party server 140 and have programmatic access to the network based publisher 112 via the programmatic interface provided by the API server 124. For example, the third party application 138 may utilize various types of data communicated with the network based publisher 112 and support one or more features or functions normally performed at the network based publisher 112. For example, the third party application 138 may receive a copy of all or a portion of the data storage 136 that includes buyer shipping data and act as the transaction intermediary between the buyer and seller with respect to functions such as shipping and payment functions. Additionally, in another embodiment, similar to the network based publisher 112, the third party application 138 may also include modules to perform operations pertaining to payment, shipping, etc. In yet another embodiment, the third party server 1.40 may collaborate with the network based publisher 112 to facilitate transactions between buyers and sellers, such as by sharing data and functionality pertaining to payment and shipping, etc.

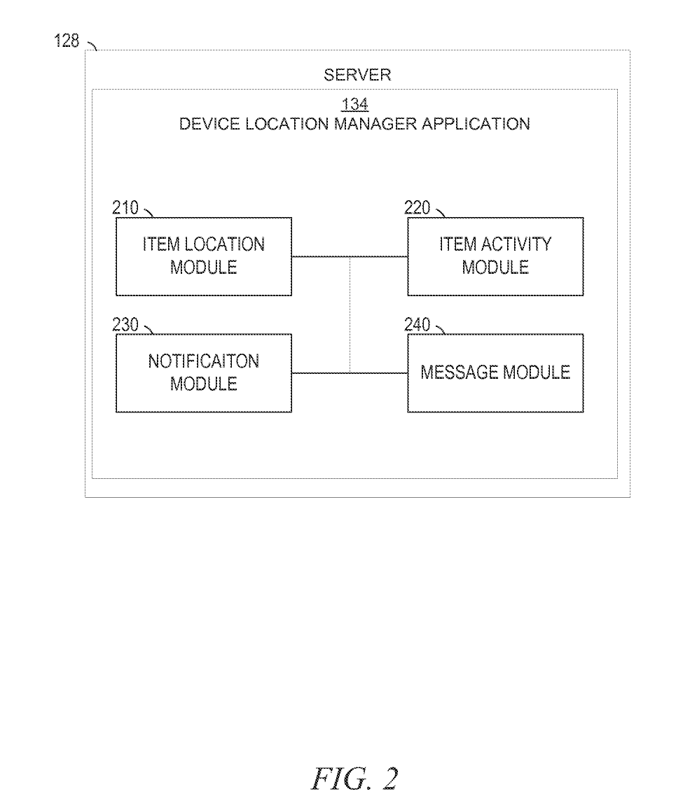

FIG. 2 is a block diagram illustrating components of a DL manager 134, according to some example embodiments. The components communicate with each other to perform the operations of the device location manager 134. The device location manager 134 is shown as including an item location module 210, an item activity module 220, a notification module 230 and a message module 240, all configured to communicate with each other e.g., via a bus, shared memory, a switch, messaging or remote/local procedure calls).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The item location module 210 may be a hardware-implemented module which manages, controls, stores, and accesses information regarding current locations of a wireless mobile devices associated with user accounts as well as previous locations of wireless mobile devices associated with user accounts. The item location module 210 requests and receives data indicative of current locations of wireless mobile devices and stores the location data in a database(s). The item location module 210 may also process and store time-related data with respect to the received location data.

The item activity module 220 may be a hardware-implemented module which manages, controls, stores, and accesses information describing activities of user accounts with respect to an item(s). The item activity module 220 processes the information to determine that one or more wireless mobile devices associated with respective user accounts are (or were) proximate to an item's location or a current location of a particular wireless mobile device. The item activity module 220 detects transactions involving the item in one or more user accounts. The item activity module 220 also identifies reviews about the item received from one or more user accounts.

The notification module 230 may be a hardware-implemented module which manages, controls, stores, and accesses information for providing an identification of one or more user accounts that have activities related to the item. The notification module 230 sends a notification to a user account associated with a wireless mobile device that is currently located proximate to an item. The notification identifies one or more user accounts that have current and/or previous activities related to the item. Such identified user accounts are associated with respective wireless mobile devices that are within a range of the item's location—or were within the range of the item's location during a particular period of time.

The message module 240 may be a hardware-implemented module which manages, controls, stores, and accesses information for receiving and sending messages between user accounts. In some embodiments, the message module 240 defines and creates a message forum to be accessed by one or more user accounts identified by the item activity module 220.

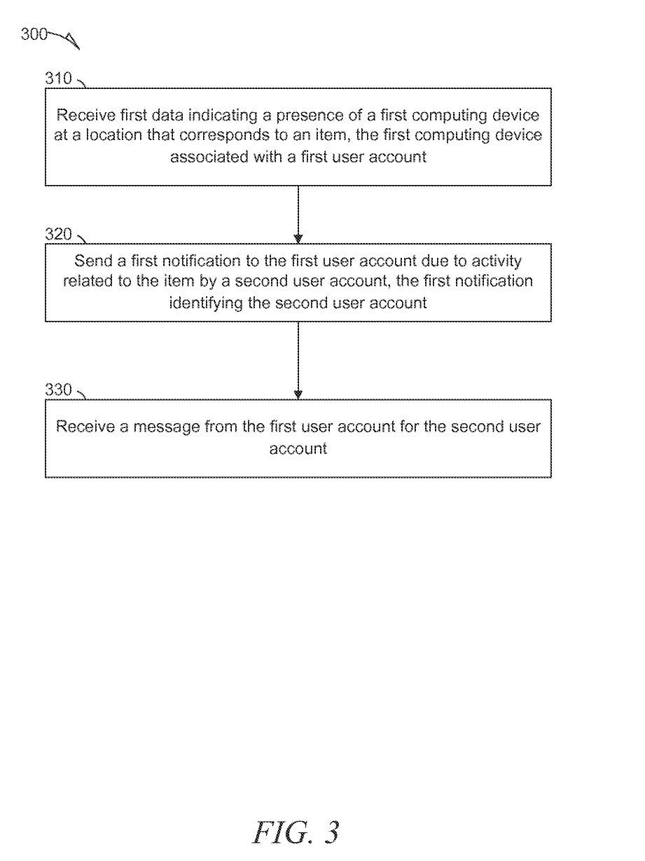

FIG. 3 is a flowchart illustrating operations of a method 300 of identifying one or more user accounts with activities related to an item, according to some example embodiments. Operations in the method 300 may be performed by the server 128, using modules described above in FIG. 2. As shown in FIG. 3, the method 300 includes operations 310, 320, 330.

The DL manager 134 identifies user accounts that have current and/or previous activities related to an item to which a first computing device is currently, proximately located. By identifying the user accounts, the DL manager 134 informs the user account associated the first computing device which user accounts will be able to provide relevant information about the item.

At step 310, the DL manager 134 receives first data indicating a presence of a first computing device at a location that corresponds to an item. The first computing device is associated with a first user account. The first data indicates that the first computing device is currently located in a physical retail space. In various embodiments, the first data indicates the first computing device is proximate to one or more items in the physical retail space. The DL manager 134 identifies a current time in relation to the current location of the first computing device.

It is understood that the DL manager 134 has access to data representative of a current location of the item. In one embodiment, the DL manager 134 receives an indication of the current location of the item from a transmitter associated with the item. In another embodiment, the DL manager 134 accesses a remote or local data storage medium that includes the indication of the current location of the item.

At step 320, the DL manager 134 sends a first notification to the first user account due to activity related to the item by a second user account. The first notification identifies the second user account. The DL manager 134 identifies the second user account based on activity in the second user account related to the item, It is understood that the DL manager 134 can identify multiple user accounts having activities related to the item.

In some embodiments, such activities include a second computing device associated with the second user account currently being within a range of the item or the first computing device. In another embodiment, such activities may include the second computing device having been within the range of the item or the current location of the first computing device during a particular period of time. The particular period of time may be a range of time measured from the current time during which the first computing device is proximate to the location of the time. In another embodiment, the activities may be a transaction in the second user account that involves the item, such as a purchase of the item or a review of the item received from the second user account.

At step 330, the DL manager 134 receives a message from the first user account for the second user account. For example, upon receipt of the first notification, a user associated with the first user account may decide to contact the user associated with the second user account in order to inquire about the item. The user associated with the first user account responds to the first notification with a message directed to the second user account. The DL manager 134 receives the message and forwards the message to the second user account. The DL manager 134 can further send a notification or an alert to the second user account that the first user account has requested information about the item.

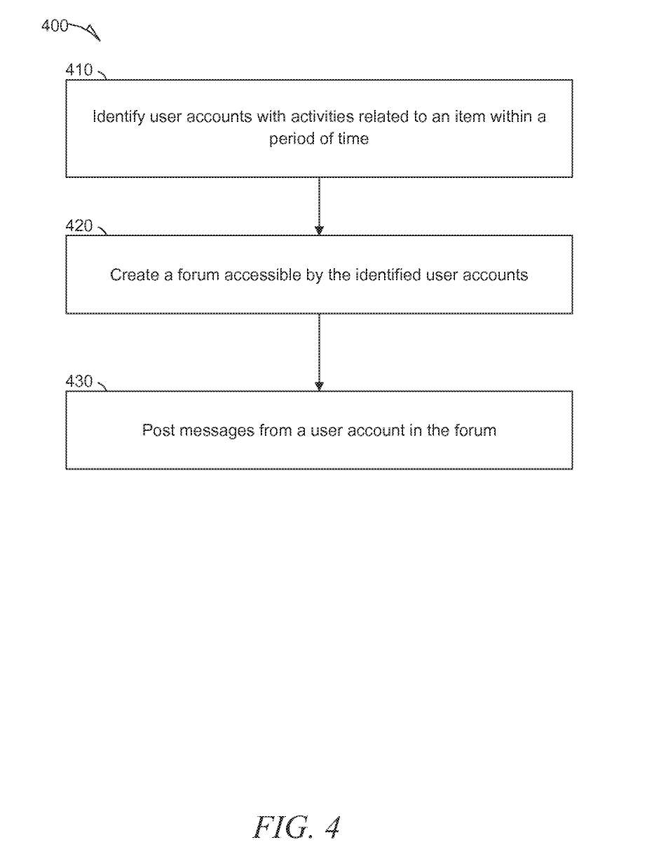

FIG. 4 is a flowchart illustrating operations of a method 400 of creating a forum for user accounts, according to some example embodiments. Operations in the method 400 may be performed by the server 128, using modules described above in FIG. 2. As shown in FIG. 4, the method 300 includes operations 410, 420, 430.

At step 410, the DL manager 134 identifies user accounts with activities related to an item within a period of time. The DL manager 134 detects a first computing device associated with a first user account is currently proximate to an item. The DL manger 134 determines a period of time measured from the current time and determines a range of distance from either the item's location or the current location of the first computing device.

The DL manager 134 identifies user accounts with activity related to the item, where the activity occurs within the period of time and/or the range of distance. For example, the DL manager 134 identifies a second computing device associated with a second user account that is currently located within the range of distance. The DL manager 134 identifies a third computing device associated with a third user account that was previously located within the range of distance at a time that still falls within the period of time. The DL manager 134 identifies a fourth computing device associated with a fourth user account that includes a transaction involving the item, where the transaction occurred within the period of time.

At step 420, the DL manager 134 creates a message forum accessible by the identified user accounts. The DL manager 134 defines and generates an online forum that is accessible only by the first user account, the second user account, the third user account and the fourth user account (“identified user accounts”).

At step 430, the DL manager 134 posts messages from a user account in the forum. The DL manager 134 may define the online forum as active for a limited period of time. The online forum allows the identified user accounts to post messages directed at one another. The online forum allows the first user account instance access to other user accounts that have personal experience with the item and that share geographical characteristics with the first user account.

When these effects are considered in aggregate, one or more of the methodologies described herein may obviate a need for certain efforts or resources that otherwise would be involved to identify and/or fulfill an inventory gap. Efforts expended by a user to identify and/or fulfill an inventory gap may be reduced by one or more of the methodologies described herein. Computing resources used by one or more machines, databases, or devices (e.g., within the network environment 100) may similarly be reduced. Examples of such computing resources include processor cycles, network traffic, and/or memory.

### Exemplary Computer Systems

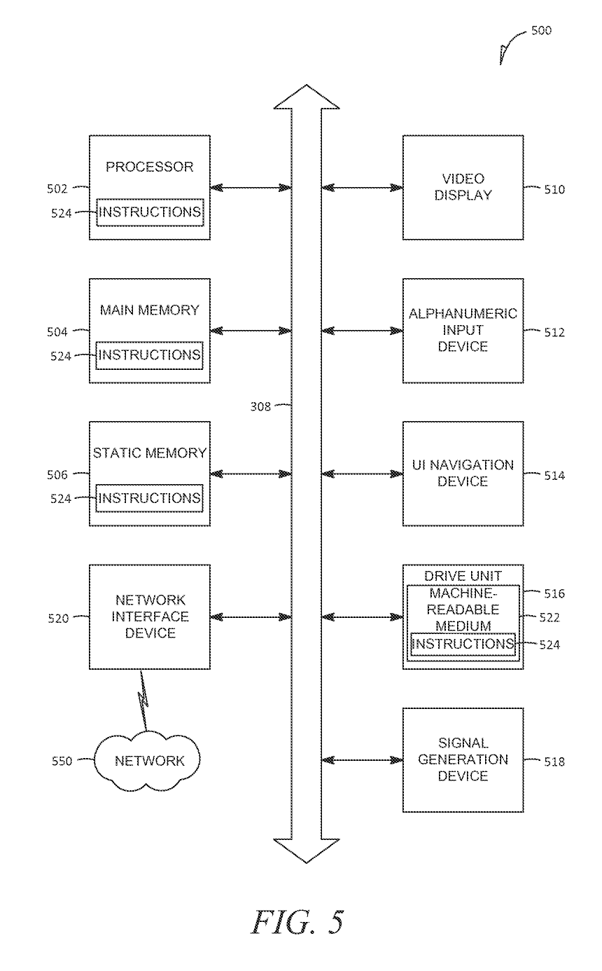

FIG. 5 shows a diagrammatic representation of machine in the example form of a computer system 500 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 300 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in example embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Furthermore, the following claims are hereby incorporated into the Detailed Description, with each claim standing on its own as a separate embodiment.

1. A computer system comprising:
a processor;
a memory device holding an instruction set executable on the processor to cause the computer system to perform operations comprising:
receiving first data indicating a presence of a first computing device at a location that corresponds to an item, the first computing device associated with a first user account;
sending a first notification to the first user account due to activity related to the item by a second user account, the first notification identifying the second user account; and
receiving a message from the first user account for the second user account.

2. The computer system as in claim 1, wherein receiving first data indicating a presence of a first computing device at a location that corresponds to an item comprises:
receiving an indication the first computing device is currently located within a range of the location that corresponds to the item during a period of time.

3. The computer system as in claim 2, wherein sending a first notification to the first user account due to activity related to the item by a second user account comprises:
identifying a transaction the second user account, the transaction indicating a purchase of the item; and
triggering the first notification based on the transaction.

4. The computer system as in claim 2, wherein sending a first notification to the first user account due to activity related to the item by a second user account comprises:
identifying a review of the item received from the second user account; and
triggering the first notification based on the review.

5. The computer system as in claim 2, wherein sending a first notification to the first user account due to activity related to the item by a second user account comprises:
identifying second data from a second computing device associated with the second user account, the second data indicating a presence of the second computing device within the range of the location that corresponds to the item during the period of time.

6. The computer system as in claim 5, further comprising:
generating a forum accessible by any user account associated with a respective computing device within the range of the location that corresponds to the item during the time period.

7. The computer system as in claim 6, wherein receiving a message from the first user account for the second user account comprises:
posting the message in the forum; and
notifying the second user account the message is posted in the forum.

8. A computer-implemented method comprising:
receiving first data indicating a presence of a first computing device at a location that corresponds to an item, the first computing device associated with a first user account;
sending a first notification to the first user account due to activity related to the item by a second user account, the first notification identifying the second user account; and
receiving a message from the first user account for the second user account.

9. The computer-implemented method as in claim 8, wherein receiving first data indicating a presence of a first computing device at a location that corresponds to an item comprises:
receiving an indication the first computing device is currently located within a range of the location that corresponds to the item during a period of time.

10. The computer-implemented method as in claim 9, wherein sending a first notification to the first user account due to activity related to the item by a second user account comprises:
identifying a transaction in the second user account, the transaction indicating a purchase of the item; and
triggering the first notification based on the transaction.

11. The computer-implemented method as in claim 9, wherein sending a first notification to the first user account due to activity related to the item by a second user account comprises:
identifying a review of the item received from the second user account; and
triggering the first notification based on the review.

12. The computer-implemented method as in claim 9, wherein sending a first notification to the first user account due to activity related to the item by a second user account comprises:
identifying second data from a second computing device associated with the second user account, the second data indicating a presence of the second computing device within the range of the location that corresponds to the item during the period of time.

13. The computer-implemented method as in claim 12., further comprising:
generating a forum accessible by any user account associated with a respective computing device within the range of the location that corresponds to the item during the time period.

14. The computer-implemented method as in claim 13, wherein receiving a message from the first user account for the second user account comprises:
posting the message in the forum; and
notifying the second user account the message is posted in the thrum.

15. A non-transitory computer-readable medium storing executable instructions thereon, which, when executed by a processor, cause the processor to perform operations including:
receiving first data indicating a presence of a first computing device at a location that corresponds to an item, the first computing device associated with a first user account;
sending a first notification to the first user account due to activity related to the item by a second user account, the first notification identifying the second user account; and
receiving a message from the first user account for the second user account.

16. The non-transitory computer-readable medium as in claim 15, wherein receiving first data indicating a presence of a first computing device at a location that corresponds to an item comprises:
receiving an indication the first computing device is currently located within a range of the location that corresponds to the item during a period of time.

17. The non-transitory computer-readable medium as in claim 16, wherein sending a first notification to the first user account due to activity related to the item by a second user account comprises:
identifying a transaction in the second user account, the transaction indicating a purchase of the item; and
triggering the first notification based on the transaction.

18. The non-transitory computer-readable medium as in claim 16, wherein sending a first notification to the first user account due to activity related to the item by a second user account comprises:
identifying a review of the item received from the second user account; and
triggering the first notification based on the review.

19. The non-transitory computer-readable medium as in claim 16, wherein sending a first notification to the first user account due to activity related to the item by a second user account comprises:
identifying second data from a second computing device associated with the second user account, the second data indicating a presence of the second computing device within the range of the location that corresponds to the item during the period of time.

20. The non-transitory computer-readable medium as in claim 9, further comprising:
generating a forum accessible by any user account associated with a respective computing device within the range of the location that corresponds to the item during the time period; and
wherein receiving a message from the first user account for the second user account comprises:
posting the message in the forum; and
notifying the second user account the message is posted in the forum.
